(19) United States
(12) Patent Application Publication
(10) Pub. No.: US 2015/0002497 A1
(43) Pub. Date: Jan. 1, 2015

(54) LIQUID CRYSTAL DISPLAY PANEL AND LIQUID CRYSTAL DISPLAY DEVICE

(71) Applicant: Shenzhen China Star Optoelectronics Technology Co., Ltd., Shenzhen, Guangdong (CN)

(72) Inventor: Chengcai Dong, Shenzhen City (CN)

(73) Assignee: Shenzhen China Star Optoelectronics Technology Co., Ltd., Shenzhen, Guangdong (CN)

(21) Appl. No.: 14/232,264

(22) PCT Filed: Jul. 2, 2013
(86) PCT No.: PCT/CN2013/078649

§ 371 Date: Aug. 11, 2014

(30) Foreign Application Priority Data
Jun. 28, 2013 (CN) 201310269523X

(51) Int. Cl. G09G 3/36

(52) U.S. Cl. CPC G09G 3/3655; G09G 2300/0426; G09G 2300/08; G09G 2320/0242
USPC 345/211; 345/87

(57) ABSTRACT

The present invention provides a liquid crystal display panel and liquid crystal display device. In liquid crystal display panel, each pixel unit in the first substrate includes first pixel electrode and second pixel electrode. Charging scan line and data line drive first and second pixel electrodes to display through first switch and second switch. Third switch is connected to discharging scan line. Input terminal of third switch is connected to first or second pixel electrode; output terminal of third switch is connected to discharging circuit. Second substrate includes first common electrode and second common electrode. First common electrode corresponds to first pixel electrode and provides first common voltage. Second common electrode corresponds to second pixel electrode and provides second common voltage. As such, the present invention can further improve the low color shift at large viewing angle and effectively reduce the image retention problem.

### BACKGROUND OF THE INVENTION

1. Field of the Invention

The present invention relates to the field of liquid crystal displaying techniques, and in particular to a liquid crystal display panel and liquid crystal display device.

2. The Related Arts

The thin-film transistor liquid crystal display device (TFT-LCD) has gradually replaced the conventional CRT for the displaying market due to the advantages of small, thin, light-weight and flickering-free. However, in TFT-LCD often suffers the low color shift problem at large viewing angle. That is, when viewing at a large angle, the color distortion is more prominent, especially for the large-size LCD panel based on VA displaying technology. To solve the above problem, a common solution is to divide a pixel area on the array substrate into a main pixel area and a secondary pixel area so that the two areas display different Gamma curve. The composition of the Gamma curves of the two areas shows smaller viewing difference at large angle and a normal angle, which improves the color distortion problem.

The common electrode on the color filter (CF) substrate is to provide common voltage to the pixel electrode on the array substrate. However, because the common electrodes on the CF substrate are often connected together, when using the design of dividing a pixel area into a main pixel area and a secondary pixel area, the main pixel area and the secondary pixel area share the same common electrode at the CD substrate side, and cannot control the common voltages required by the main pixel area and the secondary pixel area independently, which results in difficulty in controlling the Gamma curves of the two pixel areas and color distortion at large viewing angle. In addition, the common voltage shared by the main pixel area and the secondary pixel area may not be the optimal common voltage for the main pixel area and the secondary pixel area, which may lead to residual charge in main pixel area and the secondary pixel area to cause image retention problem.

### SUMMARY OF THE INVENTION

The technical issue to be addressed by the present invention is to provide a liquid crystal display panel and liquid crystal display device, able to effectively color shift problem at large viewing angle, reduce color distortion as well as reduce the image retention problem.

The present invention provides a liquid crystal display panel, which comprises: a first substrate, a second substrate, a first common electrode driver, a second common electrode driver, and a liquid crystal layer sandwiched between the first substrate and the second substrate; the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line; each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second pixel electrode; the second substrate comprising a first common electrode and a second common electrode, mutually independent; the first common electrode being corresponding to the first pixel electrode for providing a first common voltage; the first common electrode driver being connected to the first common electrode for inputting the first common voltage to the first common electrode; the second common electrode being corresponding to the second pixel electrode for providing a second common voltage; the second common electrode driver being connected to the second common electrode for inputting the second common voltage to the second common electrode; wherein the first common electrode comprising a plurality of first common sub-electrodes and the second common electrode comprising a plurality of second common sub-electrodes; the first common sub-electrodes and the second common sub-electrodes being mutually independent; the direction along the length of each first common sub-electrode being the same as the direction of the plurality of first pixel electrodes disposed adjacently and continuously so that each first common sub-electrode being corresponding to a column or a row of the first pixel electrodes to provide the first common voltage required by the first pixel electrodes for displaying images; the direction along the length of each second common sub-electrode being the same as the direction of the plurality of second pixel electrodes disposed adjacently and continuously so that each second common sub-electrode being corresponding to a column or a row of the second pixel electrodes to provide the second common voltage required by the second pixel electrodes for displaying images.

According to a preferred embodiment of the present invention, all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

According to a preferred embodiment of the present invention, the first common sub-electrodes and the second common sub-electrode have a strip shape.

The present invention provides a liquid crystal display panel, which comprises: a first substrate, a second substrate, and a liquid crystal layer sandwiched between the first substrate and the second substrate; the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line; each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second pixel electrode; the second substrate comprising a first common electrode and a second common electrode; the first common electrode being corresponding to the first pixel electrode for providing a first common voltage; the second common electrode being corresponding to the second pixel electrode for providing a second common voltage.

According to a preferred embodiment of the present invention, the first common electrode and the second common electrode are mutually independent; the first common electrode comprises a plurality of first common sub-electrodes and the second common electrode comprises a plurality of second common sub-electrodes; the first common sub-electrodes and the second common sub-electrodes are mutually independent; the direction along the length of each first common sub-electrode is the same as the direction of the plurality of first pixel electrodes disposed adjacently and continuously so that each first common sub-electrode is corresponding to a column or a row of the first pixel electrodes to provide the first common voltage required by the first pixel electrodes for displaying images; the direction along the length of each second common sub-electrode is the same as the direction of the plurality of second pixel electrodes disposed adjacently and continuously so that each second common sub-electrode is corresponding to a column or a row of the second pixel electrodes to provide the second common voltage required by the second pixel electrodes for displaying images.

According to a preferred embodiment of the present invention, all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

According to a preferred embodiment of the present invention, the first common sub-electrodes and the second common sub-electrode have a strip shape.

According to a preferred embodiment of the present invention, the liquid crystal display panel comprises a first common electrode driver and a second common electrode driver; the first common electrode driver is connected to the first common electrode for inputting the first common voltage to the first common electrode; the second common electrode driver is connected to the second common electrode for inputting the second common voltage to the second common electrode.

According to a preferred embodiment of the present invention, the first substrate further comprises a third common electrode, and the discharging circuit comprises a first capacitor and a second capacitor; when the input terminal of the third switch is connected to either one of the first pixel electrode or the second pixel electrode, one end of the first capacitor is connected to the other pixel electrode; the other end of the first capacitor is connected to one end of the second capacitor, the other end of the second capacitor is connected to the third common electrode of the first substrate, the output terminal of the third switch is connected to between the first capacitor and the second capacitor; wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; under the effect of the first capacitor and the second capacitor, a non-zero default voltage difference is formed between the first pixel electrode and the second pixel electrode.

According to a preferred embodiment of the present invention, the first substrate further comprises a third common electrode, and the discharging circuit is a discharging capacitor; the input terminal of the third switch is connected to either one of the first pixel electrode or the second pixel electrode, the output terminal of the third switch is connected to one end of the discharging capacitor, the other end of the discharging capacitor is connected to the third common electrode of the first substrate, wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; controlling the capacitance of the discharging capacitor, a non-zero default voltage difference is formed between the first pixel electrode and the second pixel electrode.

According to a preferred embodiment of the present invention, the charging scan line, the discharging scan line, the first switch, the second switch, the third switch and the discharging circuit are all located between the first pixel electrode and the second pixel electrode.

According to a preferred embodiment of the present invention, the first switch, the second switch and the third switch are all thin-film transistors; the control terminal of the switch is also the gate of the thin-film transistor; the input terminal of the switch is the source of the thin-film transistor; and the output terminal of the switch is the drain of the thin-film transistor.

The present invention provides a liquid crystal display device, which comprises a liquid crystal display panel; the liquid crystal display panel further comprising: a first substrate, a second substrate, and a liquid crystal layer sandwiched between the first substrate and the second substrate; the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line; each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second pixel electrode; the second substrate comprising a first common electrode and a second common electrode; the first common electrode being corresponding to the first pixel electrode for providing a first common voltage; the second common electrode being corresponding to the second pixel electrode for providing a second common voltage.

According to a preferred embodiment of the present invention, the first common electrode and the second common electrode are mutually independent; the first common electrode comprises a plurality of first common sub-electrodes and the second common electrode comprises a plurality of second common sub-electrodes; the first common sub-electrodes and the second common sub-electrodes are mutually independent; the direction along the length of each first common sub-electrode is the same as the direction of the plurality of first pixel electrodes disposed adjacently and continuously so that each first common sub-electrode is corresponding to a column or a row of the first pixel electrodes to provide the first common voltage required by the first pixel electrodes for displaying images; the direction along the length of each second common sub-electrode is the same as the direction of the plurality of second pixel electrodes disposed adjacently and continuously so that each second common sub-electrode is corresponding to a column or a row of the second pixel electrodes to provide the second common voltage required by the second pixel electrodes for displaying images.

According to a preferred embodiment of the present invention, all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

According to a preferred embodiment of the present invention, the first common sub-electrodes and the second common sub-electrode have a strip shape.

According to a preferred embodiment of the present invention, the liquid crystal display panel comprises a first common electrode driver and a second common electrode driver; the first common electrode driver is connected to the first common electrode for inputting the first common voltage to the first common electrode; the second common electrode driver is connected to the second common electrode for inputting the second common voltage to the second common electrode.

According to a preferred embodiment of the present invention, the first substrate further comprises a third common electrode, and the discharging circuit comprises a first capacitor and a second capacitor; when the input terminal of the third switch is connected to either one of the first pixel electrode or the second pixel electrode, one end of the first capacitor is connected to the other pixel electrode; the other end of the first capacitor is connected to one end of the second capacitor, the other end of the second capacitor is connected to the third common electrode of the first substrate, the output terminal of the third switch is connected to between the first capacitor and the second capacitor; wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; under the effect of the first capacitor and the second capacitor, a non-zero default voltage difference is formed between the first pixel electrode and the second pixel electrode.

According to a preferred embodiment of the present invention, the first substrate further comprises a third common electrode, and the discharging circuit is a discharging capacitor; the input terminal of the third switch is connected to either one of the first pixel electrode or the second pixel electrode, the output terminal of the third switch is connected to one end of the discharging capacitor, the other end of the discharging capacitor is connected to the third common electrode of the first substrate, wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; controlling the capacitance of the discharging capacitor, a non-zero default voltage difference is formed between the first pixel electrode and the second pixel electrode.

According to a preferred embodiment of the present invention, the charging scan line, the discharging scan line, the first switch, the second switch, the third switch and the discharging circuit are all located between the first pixel electrode and the second pixel electrode.

The efficacy of the present invention is that to be distinguished from the state of the art. In the liquid crystal display panel according to the present invention, each pixel unit in the first substrate comprises the first pixel electrode and the second pixel electrode, and the corresponding charging scan line and data line of the pixel unit drive the first pixel electrode and the second pixel electrode to display through the first switch and the second switch; the third switch is connected to the corresponding discharging scan line of the pixel unit; the input terminal of the third switch is connected to the first pixel electrode or the second pixel electrode; the output terminal of the third switch is connected to the discharging circuit; when driving the first pixel electrode and the second pixel electrode to display, the effect of the discharging circuit makes a non-zero default voltage difference formed between the first pixel electrode and the second pixel electrode. In other words, the voltage at the first pixel electrode is different from the voltage at the second pixel electrode, which leads to the result that the orientation of the liquid crystal molecules of the liquid crystal layer corresponding to the first pixel electrode and the second pixel electrode are different so as to reduce the color different at large viewing angle. In addition, the second substrate comprises the first common electrode and the second common electrode. The first common electrode corresponds to the first pixel electrode and provides the first common voltage required by the first pixel electrode to display images. The second common electrode corresponds to the second pixel electrode and provides the second common voltage required by second first pixel electrode to display images. As such, by respectively controlling the common voltages required by the first pixel electrode and the second pixel electrode to display images, the present invention can further improve the low color shift and effectively reduce the image retention problem.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a liquid crystal display panel of an embodiment of the present invention;

FIG. 2 is a schematic view showing the structure of the first substrate of FIG. 1;

FIG. 3 is a schematic view showing the structures of the pixel electrodes on the first substrate and the common electrodes on the second substrate of FIG. 1;

FIG. 4 is a is a schematic view showing the deflection of the liquid crystal molecules of the liquid crystal layer under the control of the pixel electrodes on the first substrate and the common electrodes on the second substrate of FIG. 1; and

FIG. 5 is a schematic view showing structure of the first substrate of a liquid crystal display panel of another embodiment of the present invention.

### DETAILED DESCRIPTION OF THE PREFERRED EMBODIMENTS

The following refers to the specific embodiments and drawings to describe the present invention in details.

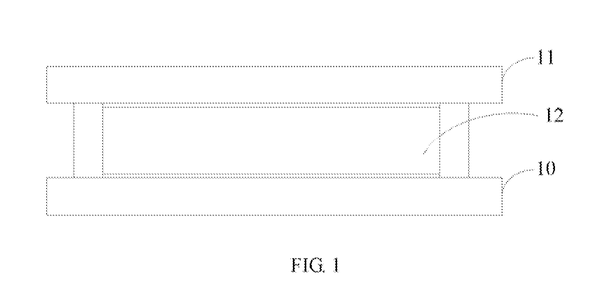

Referring to FIGS. 1-3, in a liquid crystal display panel of an embodiment of the present invention, the liquid crystal display panel comprises a first substrate 10, a second substrate 11, and a liquid crystal layer 12 sandwiched between the first substrate 10 and the second substrate 11; wherein the first substrate is an array substrate of the liquid crystal display panel and the second substrate is a color filter substrate of the liquid crystal display panel.

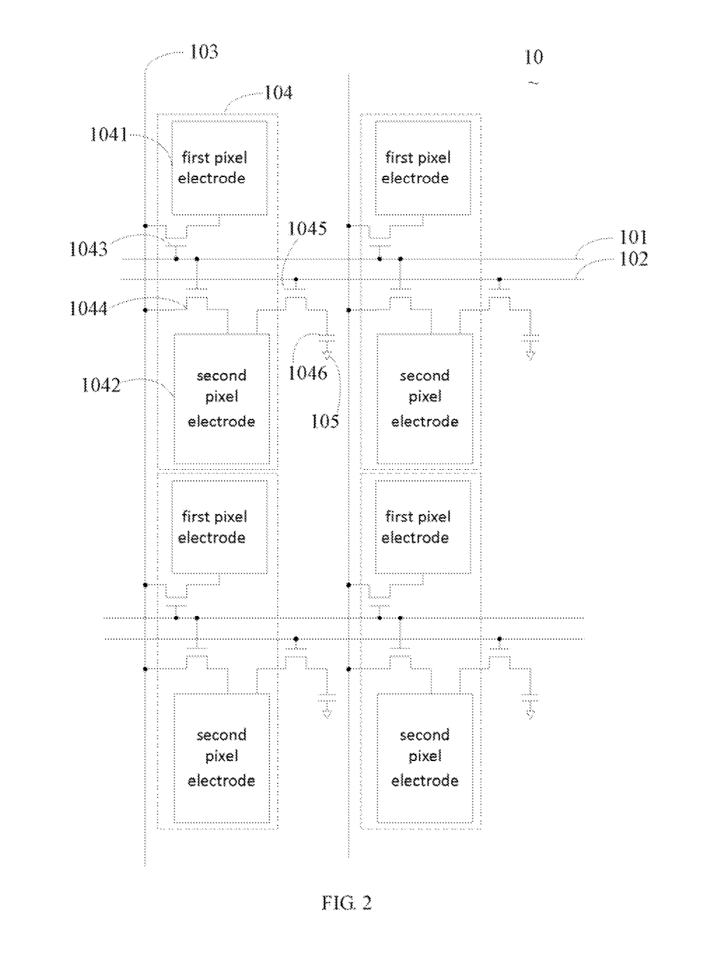

Further referring to FIG. 2, FIG. 2 shows a schematic view of the structure of the first substrate 10 of the present embodiment. The first substrate 10 comprises a plurality of charging scan lines 101, a plurality of discharging scan lines 102, a plurality of data lines 103 and, a plurality of pixel units 104, arranged in a matrix format. The plurality of charging scan lines 101 and the plurality of discharging scan lines 102 are arranged interleavingly in the row direction. Each of pixel units 104 corresponds to a charging scan line 101, a discharging scan line 102 and a data line 103. Each of pixel units 104 further comprises: a first pixel electrode 1041, a second pixel electrode 1042, and a first switch 1043 and a second switch 1044 for operating on the first pixel electrode 1041 and the second pixel electrode 1042 respectively. Each of pixel units 104 further comprises a third switch 1045 and a discharging circuit 1046. The first pixel electrode 1041 and the second pixel electrode 1042 are arranged along the column direction. Each switch comprises a control terminal, an input terminal and an output terminal. The control terminals of the first switch 1043 and the second switch 1044 are connected to the charging scan line 101 of the pixel unit, the input terminals of the first switch 1043 and the second switch 1044 are connected to the data line 103 of the pixel unit, the output terminal of the first switch 1043 is connected to the first pixel electrode 1041, the output terminal of the second switch 1044 is connected to the second pixel electrode 1042. The control terminal of the third switch 1045 is connected to the discharging scan line 102, the input terminal of the third switch 1045 is connected to the second pixel electrode 1042, and the output terminal of the third witch 1045 is connected to the discharging circuit 1046. In the instant embodiment, the first substrate 10 further comprises a third common electrode 105 and the discharging circuit 1046 is a discharging capacitor 1046. The output terminal of the third switch 1045 is connected to one end of the discharging capacitor 1046, and the other end of the discharging capacitor 1046 is connected to the third common electrode of the first substrate 10.

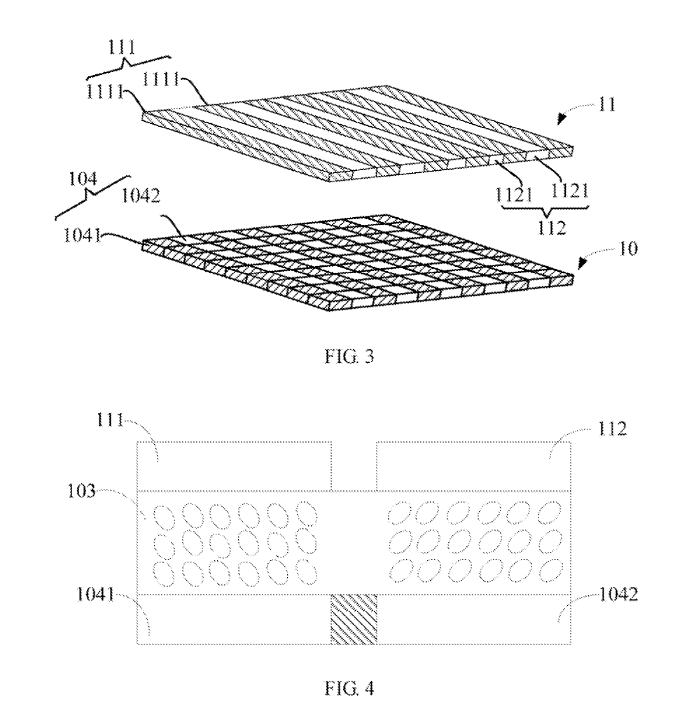

Referring to FIG. 3, FIG. 3 is a schematic view showing the structures of the pixel electrodes on the first substrate 10 and the common electrodes on the second substrate 11 of the instant embodiment. The second substrate 11 comprises a first common electrode 111 and a second common electrode 112, mutually independent. The number of first common electrode 111 and the number of the second common electrode 112 are both one. The first common electrode 111 corresponds to the first pixel electrode 1041 for providing a first common voltage. The second common electrode 112 corresponds to the second pixel electrode 1042 for providing a second common voltage. Specifically, the first common electrode 111 comprises a plurality of strip-shaped first common sub-electrodes 1111 (the figure only showing two) and the second common electrode 112 comprises a plurality of strip-shaped second common sub-electrodes 1121 (the figure only showing two). The direction along the length of each first common sub-electrode 1111 is the same as the direction of a column of first pixel electrodes 1041. In other words, the direction along the length of each first common sub-electrode 1111 is the same as the column so that a row of first pixel electrodes 1041 of each column of pixel units 104 corresponds to a first common sub-electrode 1111. The direction along the length of each second common sub-electrode 1121 is the same as the direction of a column of second pixel electrodes 1042. In other words, the direction along the length of each second common sub-electrode 1121 is the same as the column so that a row of second pixel electrodes 1042 of each column of pixel units 104 corresponds to a second common sub-electrode 1121. The first common sub-electrode 1111 and the second common sub-electrode 1121 are mutually independent and isolated from each other, with the direction of arrangement the same as the direction of the arrangement of the first pixel electrode 1041 and the second pixel electrode 1042. In the row direction, the first pixel electrode 1041 and the second pixel electrode 1042 are arranged interleavingly. The first common sub-electrode 1111 and the second common sub-electrode 1121 are also arranged interleavingly along the row direction. Furthermore, all the first common sub-electrodes 1111 are electrically connected in area of the second substrate 11 corresponding to the peripheral area of the active area of the liquid crystal display panel; and all the first common sub-electrodes 1111 electrically connected act as a first common electrode 111. All the second common sub-electrodes 1121 are electrically connected in area of the second substrate 11 corresponding to the peripheral area of the active area of the liquid crystal display panel; and all the second common sub-electrodes 1121 electrically connected act as a second common electrode 112. In actual application, when manufacturing the first common electrode 111, an entire piece of transparent electrode can be used, for example, by mapping the entire piece of transparent electrode to the active areas of the liquid crystal display panel and dividing into a plurality of strip-shaped electrodes to obtain the corresponding plurality of first common sub-electrodes 1111. The area on the entire piece of the transparent electrode corresponding to the peripheral area of the active area of the liquid crystal display panel is not divided so as to obtain the electrical connection of the plurality of first common sub-electrodes 1111 through the corresponding transparent electrode of the peripheral area of the active areas. The second common electrode 112 can be manufactured in the similar manner.

In other embodiments, all the first common sub-electrodes can be electrically connected in area of the second substrate corresponding to the active area of the liquid crystal display panel; and all the second common sub-electrodes can be electrically connected in area of the second substrate corresponding to the active area of the liquid crystal display panel. No specific restriction is imposed. In addition, the first common sub-electrode and the second common sub-electrode can also be of other shapes, such as, a pillar or a triangle. No specific shape is imposed.

The liquid crystal display panel further comprises a first common electrode driver and a second common electrode driver. The first common electrode driver is connected to the first common electrode 111. Specifically, the first common electrode driver is connected to the first common sub-electrodes 1111 to supply a first common voltage to the first common sub-electrodes 1111. The second common electrode driver is connected to the second common electrode 112. Specifically, the second common electrode driver is connected to the second common sub-electrodes 1121 to supply a second common voltage to the second common sub-electrodes 1121. The first common electrode driver and the second common electrode driver can be realized by integrated driving IC. In other embodiments, driving circuits with individual components can be to provide the common voltages to the first common electrode and the second common electrode. No specific restriction is imposed. In addition, respective constant voltage signals can be applied to the first common electrode and the second common electrode by two reference voltage sources without the use of the first common electrode driver and the second common electrode driver.

In the instant embodiment, through the effect of discharging capacitor 1046, a non-zero voltage difference exists between the first pixel electrode 1041 and the second pixel electrode 1042 to achieve low color shirt. By using the first common electrode 111 and the second common electrode 112 with the common voltages required for displaying images by the first pixel electrode 1041 and the second pixel electrode 1042, the instant embodiment can further enhance the low color shift effect of the liquid crystal display panel and reduce the image retention problem.

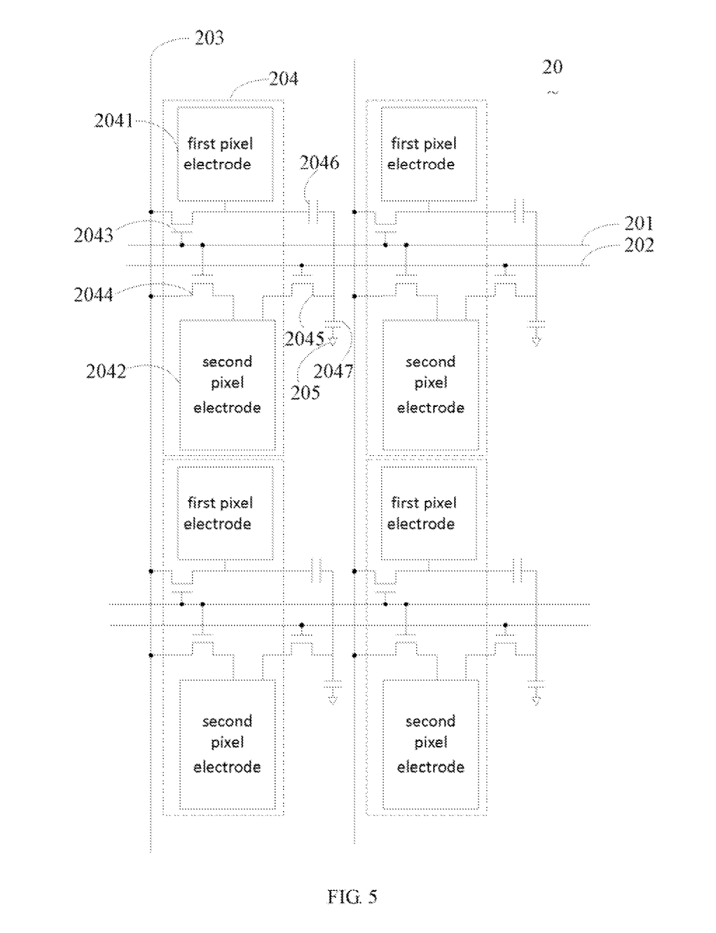

Specifically, when driving the liquid crystal display panel to display, the scan lines are scanned in a line-by-line manner. First, the scan signal is inputted to the charging scan line 101 to control the first switch 1043 and the second switch 1044 to become conductive, the data line 103 inputs data signal through the first switch 1043 and the second switch 1044 to the first pixel electrode 1041 and the second pixel electrode 1042. At this point, the first pixel electrode 1041 and the second pixel electrode 1042 are at the same voltage level. Also, according to the displaying requirement of the first pixel electrode 1041 and the second pixel electrode 1042, the first common voltage is applied by the first common electrode driver to the first common sub-electrodes 1111 of the second substrate 11 to provide the first common voltage required by the first pixel electrode 1041 for displaying images; and the second common voltage is applied by the second common electrode driver to the second common sub-electrodes 1121 of the second substrate 11 to provide the second common voltage required by the second pixel electrode 1042 for displaying images. Through collaboration of the charging scan line 101, the data line 103, the first common sub-electrodes 1111 and the second common sub-electrodes 1121 of the second substrate 11, the first pixel electrode 1041 and the second pixel electrode 1042 are driven to display. Then, the inputting scan signal to the charging scan line 101 is stopped and the scan signal is inputted to the discharging scan line 102 to control the third switch 1045 to become conductive. Because the input terminal of the third switch 1045 is connected to the second pixel electrode 1042 and the output terminal of the third switch 1045 is connected to the discharging capacitor 1046, the second pixel electrode 1042 is electrically connected to the discharging capacitor 1046 when the third switch 1045 is conductive. Based on the viewing angle requirement, by controlling the voltage level of the discharging capacitor 1046, such as, discharging capacitor 1046 having a voltage level lower than the voltage level of the second pixel electrode 1042, a part of charges of the second pixel electrode 1042 will transfer when the second pixel electrode 1042 is electrically connected to the discharging capacitor 1046. As a result, the voltage level of the second pixel electrode 1042 is lower than the voltage level of the first pixel electrode 1041; thus, a non-zero default voltage difference is formed between the first pixel electrode 1041 and the second electrode 1042. The difference of the respective voltage levels of the first pixel electrode 1041 and the second electrode 1042, as shown in FIG. 4, will cause the liquid crystal molecules of the liquid crystal layer 103 corresponding to the first pixel electrode 1041 and the second electrode 1042 respectively deflect differently. As such, the color difference at large viewing angle is reduced and the low color shift effect at large viewing angle is achieved.

Furthermore, based on the displaying requirement at different viewing angles, the common voltages required by the first pixel electrode 1041 and the second electrode 1042 for displaying images may also be different. Through the first common sub-electrodes 1111 and the second common sub-electrodes 1121 of the instant embodiment, the optimal respective common voltages required by the first pixel electrode 1041 and the second electrode 1042 for displaying images can be provided, instead of the conventional technique using a common electrode to provide the same common voltage to both the first pixel electrode 1041 and the second electrode 1042. As such, by controlling the voltage difference between the first pixel electrode 1041 and the first common sub-electrodes 1111 and the voltage difference between the second pixel electrode 1042 and the second common sub-electrodes 1121 to be different, the deflection direction of the liquid crystal molecules corresponding to the first pixel electrode 1041 and the deflection direction of the liquid crystal molecules corresponding to the second pixel electrode 1042 are also different, so as to further improve the low color shift effect. Also, the first pixel electrode 1041 and the second pixel electrode 1042 can both receive respective optimal common voltages to display images, to further effectively reduce the charge retention of the first pixel electrode 1041 and the second pixel electrode 1042 as well as reduce the image retention problem.

In the instant embodiment, the charging scan line 101, the discharging scan line 102, the first switch 1043, the second switch 1044, the third switch 1043 and the discharging capacitor 1046 are also disposed in the non-transparent area between the first pixel electrode 1041 and the second pixel electrode 1042 so as to improve the aperture ratio of the liquid crystal display panel. In other embodiments, the charging scan line, the discharging scan line and the switches can be disposed in the non-transparent area between pixel units. For example, for two adjacent pixel units along the row direction, the charging scan line, the discharging scan line, the three switches and the capacitor corresponding to the pixel unit can be disposed in the non-transparent area between the pixel unit and the adjacent previous pixel unit.

Moreover, the first switch 1043, the second switch 1044 and the third switch 1045 are all thin-film transistors; the control terminal of the switch corresponds to the gate of the thin-film transistor; the input terminal of the switch corresponds to the source of the thin-film transistor; and the output terminal of the switch corresponds to the drain of the thin-film transistor. Obviously, in other embodiments, the three switches 1043, 1044, 1045 may also be other control switches, such as, Darlington transistor or triode.

In other embodiments, the input terminal of the third switch can also be connected to the first pixel electrode. Through the effect of the discharging capacitor, the voltage level of the first pixel electrode is changed, resulting in forming a non-zero voltage difference between the first pixel electrode and the second pixel electrode to achieve the low color shift effect.

In addition, in other embodiments, the first pixel electrode and the second pixel electrode can be arranged along the column direction. In such case, the direction along the length of the first common sub-electrodes is the row direction, and each first common sub-electrode corresponds to a row of first pixel electrodes to provide the first common voltage. The direction along the length of the second common sub-electrodes is also the row direction, and each second common sub-electrode corresponds to a row of second pixel electrodes to provide the second common voltage. Furthermore, the second substrate may comprise a plurality of independent first common electrodes and a plurality of second common electrodes, and the first common electrodes and the second common electrodes are also mutually independent. In such case, each first common electrode corresponds to a row or a column of first pixel electrodes (depending on the arrangement direction of the first pixel electrodes and the second pixel electrodes), and each first common electrode is connected to a first common electrode driver. Each second common electrode corresponds to a row or a column of second pixel electrodes, and each second common electrode is connected to a second common electrode driver. As such, the above embodiment can also achieve the object of individually applying respective common voltage to the first pixel electrode and the second pixel electrode.

In yet other embodiments, the first common electrode and the second common electrode can also be electrically connected so that the first common electrode and the second common electrode can receive the first common voltage and the second common voltage respectively through the appropriate divider circuit or boost circuit. In such case, only a driver or a reference voltage source is required to provide the voltage signal, for example, through a driving circuit or a reference voltage source to apply the first common voltage to the first common electrode to provide the optimal first common voltage required by the first pixel electrode to display images. If the second common voltage required by the second pixel electrode is smaller than the first common voltage, the first common electrode and the second common electrode can be electrically connected through a divider resistor so that the first common voltage will become a smaller voltage after the divider resistor required for the second pixel electrode when the first common voltage is applied to the first common electrode. The resistance of the divider resistor can be designed according to the optimal second common voltage required by the second pixel electrode. As such, the first common electrode and the second common electrode can obtain respective required common voltages so that the first pixel electrode and the second pixel electrode can receive respective optimal common voltages to display images.

In the above embodiment, the discharging circuit is realized by a discharging capacitor. Referring to FIG. 5, in the liquid crystal display panel of another embodiment of the present invention, the discharging circuit is realized with two serially connected capacitors. The structure of second substrate in the instant embodiment is the same as the second substrate of the previous embodiment. The discharging circuit of the instant embodiment comprises a first capacitor 2046 and a second capacitor 2047, wherein the input terminal of the third switch 2045 is connected to the second pixel electrode, one end of the first capacitor 2046 is connected to the first pixel electrode 2041; the other end of the first capacitor 2046 is connected to one end of the second capacitor 2047, the other end of the second capacitor 2047 is connected to the third common electrode 205 of the first substrate 20. The output terminal of the third switch 2045 is connected to between the first capacitor 2046 and the second capacitor 2047.

When driving the liquid crystal display panel to display, the scan signal is inputted to the charging scan line 201 to control the first switch 2043 and the second switch 2044 to become conductive, and the data line 203 inputs data single through the first switch 2043 and the second switch 2044 to the first pixel electrode 2041 and the second pixel electrode 2042 respectively. At this point, the first pixel electrode 2041 and the second pixel electrode 2042 have the same voltage level. The driving method to the second substrate is the same as the previous embodiment and the description is omitted. Then, the inputting scan signal to the charging scan line 201 is stopped and the scan signal is inputted to the discharging scan line 202 to control the third switch 2045 to become conductive, which leads to the electrical connection between the second pixel electrode 2042 and the discharging circuit. The first capacitor 2046 and the second capacitor 2047 uses serial connection to connect to the first pixel electrode 2041. When the data line 203 provides voltage signal (i.e., data signal) to the first pixel electrode 2041, the voltage signal is also applied to the shunt formed by the first capacitor 2046 and the second capacitor 2047. Based on the voltage division of serially connected capacitors, the voltage between the first capacitor 2046 and the second capacitor 2047 is lower than the voltage inputted by the data line 203. In other words, the voltage between the first capacitor 2046 and the second capacitor 2047 is lower than the voltage of the first pixel electrode 2041, and the voltage between the first capacitor 2046 and the second capacitor 2047 is lower than the voltage of the second pixel electrode 2042. As such, when the third switch 2045 is conductive, a part of charges of the second pixel electrode 2042 is transferred so that the voltage of the second pixel electrode 2042 is lower than the voltage of the first pixel electrode 2041. Therefore, the liquid crystal molecules corresponding to the first pixel electrode 2041 and the second pixel electrode 2042 will have different deflection direction to achieve the low color shift effect.

In addition, the structure of the second substrate of the instant embodiment is similar to the previous embodiment. In other words, the second substrate comprises mutually independent first common electrode and second common electrode to provide respective optimal common voltages to the first pixel electrode 2041 and the second pixel electrode for displaying images, so as to control the deflection of the corresponding liquid crystal molecules according to the viewing angle, which leads to improving the low color shift at large viewing angle as well as reducing the image retention problem.

In yet other embodiments, the discharging circuit can be a divider resistor so that the input terminal of the third switch is connected to the first pixel electrode and the output terminal is connected to one end of the divider resistor. The other end of the divider resistor is grounded. When the third switch is conductive, the first pixel electrode is electrically connected to the divider resistor. The voltage of the first pixel electrode, after the divider resistor, will form a non-zero default voltage difference with the voltage of the second pixel electrode.

The present invention further provides an embodiment of a liquid crystal display device, which comprises a liquid crystal display panel of any of the above embodiments.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display panel, which comprises: a first substrate, a second substrate, a first common electrode driver, a second common electrode driver, and a liquid crystal layer sandwiched between the first substrate and the second substrate;
the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line;
each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second, pixel electrode;
the second substrate comprising a first common electrode and a second common electrode, mutually independent; the first common electrode being corresponding to the first pixel electrode for providing a first common voltage; the first common electrode driver being connected to the first common electrode for inputting the first common voltage to the first common electrode, the second common electrode being corresponding to the second pixel electrode for providing a second common voltage; the second common electrode driver being connected to the second common electrode for inputting the second common voltage to the second common electrode;
wherein the first common electrode comprising a plurality of first common sub-electrodes and the second common electrode comprising a plurality of second common sub-electrodes; the first common sub-electrodes and the second common sub-electrodes being mutually independent; the direction along the length of each first common sub-electrode being the same as the direction of the plurality of first pixel electrodes disposed adjacently and continuously so that each first common sub-electrode being corresponding to a column or a row of the first pixel electrodes to provide the first common voltage required by the first pixel electrodes for displaying images; the direction along the length of each second common sub-electrode being the same as the direction of the plurality of second pixel electrodes disposed adjacently and continuously so that each second common sub-electrode being corresponding to a column or a row of the second pixel electrodes to provide the second common voltage required by the second pixel electrodes for displaying images.

2. The liquid crystal display panel as claimed in claim 1, wherein:
all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

3. The liquid crystal display panel as claimed in claim 1, wherein;
the first common sub-electrodes and the second common sub-electrode have a strip shape.

4. A liquid crystal display panel, which comprises: a first substrate, a second substrate, and a liquid crystal layer sandwiched between the first substrate and the second substrate;
the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line;
each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and, the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second pixel electrode;
the second substrate comprising a first common electrode and a second common electrode; the first common electrode being corresponding to the first pixel electrode for providing a first common voltage; the second common electrode being corresponding to the second pixel electrode for providing a second common voltage.

5. The liquid crystal display panel as claimed in claim 4, wherein
the first common electrode and the second common electrode are mutually independent; the first common electrode comprises a plurality of first common sub-electrodes and the second common electrode comprises a plurality of second common sub-electrodes; the first common sub-electrodes and the second common sub-electrodes are mutually independent; the direction along the length of each first common sub-electrode is the same as the direction of the plurality of first pixel electrodes disposed adjacently and continuously so that each first common sub-electrode is corresponding to a column or a row of the first pixel electrodes to provide the first common voltage required by the first pixel electrodes for displaying images; the direction along the length of each second common sub-electrode is the same as the direction of the plurality of second pixel electrodes disposed adjacently and continuously so that each second common sub-electrode is corresponding to a column or a row of the second pixel electrodes to provide the second common voltage required by the second pixel electrodes for displaying images.

6. The liquid crystal display panel as claimed in claim 5, wherein:
all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

7. The liquid crystal display panel as claimed in claim 5, wherein:
the first common sub-electrodes and the second common sub-electrode have a strip shape.

8. The liquid crystal display panel as claimed in claim 4, wherein:
the liquid crystal display panel comprises a first common electrode driver and a second common electrode driver; the first common electrode driver is connected to the first common electrode for inputting the first common voltage to the first common electrode; the second common electrode driver is connected to the second common electrode for inputting the second common voltage to the second common electrode.

9. The liquid crystal display panel as claimed in claim 4, wherein:
the first substrate further comprises a third common electrode, and the discharging circuit comprises a first capacitor and a second capacitor when the input terminal of the third switch is connected to either one of the first pixel electrode or the second pixel electrode, one end of the first capacitor is connected to the other pixel electrode; the other end of the first capacitor is connected to one end of the second capacitor, the other end of the second capacitor is connected to the third common electrode of the first substrate, the output terminal of the third switch is connected to between the first capacitor and the second capacitor;
wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; under the effect of the first capacitor and the second capacitor, a non-zero default voltage difference is formed between the first pixel electrode and the second pixel electrode.

10. The liquid crystal display panel as claimed in claim 4, wherein:
the first substrate further comprises a third common electrode, and the discharging circuit is a discharging capacitor; the input terminal of the third switch is connected to either one of the first pixel electrode or the second pixel electrode, the output terminal of the third switch is connected to one end of the discharging capacitor, the other end of the discharging capacitor is connected to the third common electrode of the first substrate;
wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; controlling the capacitance of the discharging capacitor, a non-zero default voltage difference is formed between the first pixel electrode and the second pixel electrode.

11. The liquid crystal display panel as claimed in claim 4, wherein:
the charging scan line, the discharging scan line, the first switch, the second switch, the third switch and the discharging circuit are all located between the first pixel electrode and the second pixel electrode.

12. The liquid crystal display panel as claimed in claim 4, wherein:
the first switch, the second switch and the third switch are all thin-film transistors; the control terminal of the switch is also the gate of the thin-film transistor; the input terminal of the switch is the source of the thin-film transistor; and the output terminal of the switch is the drain of the thin-film transistor.

13. A liquid crystal display device, which comprises a liquid crystal display panel; the liquid crystal display panel further comprising: a first substrate, a second substrate, and a liquid crystal layer sandwiched between the first substrate and the second substrate:
the first substrate comprising a plurality of charging scan lines, a plurality of discharging scan lines, a plurality of data lines and a plurality of pixel units, arranged in a matrix format, with each of pixel units corresponding to a charging scan line, a discharging scan line and a data line;
each of pixel units further comprising: a first pixel electrode, a second pixel electrode, and a first switch and a second switch for operating on the first pixel electrode and the second pixel electrode respectively; each of pixel units further comprising a third switch and a discharging circuit; each switch comprising a control terminal, an input terminal and an output terminal; the control terminals of the first switch and the second switch being connected to the charging scan line of the pixel unit, the input terminals of the first switch and the second switch being connected to the data line of the pixel unit, the output terminal of the first switch being connected to the first pixel electrode, the output terminal of the second switch being connected to the second pixel electrode, the control terminal of the third switch being connected to the discharging scan line, the input terminal of the third switch being connected to the first pixel electrode or the second pixel electrode, the output terminal of the third witch being connected to the discharging circuit to make the first pixel electrode and the second pixel electrode forming a non-zero default voltage difference when driving the first pixel electrode and the second pixel electrode:
the second substrate comprising a first common electrode and a second common electrode; the first common electrode being corresponding to the first pixel electrode for providing a first common voltage; the second common electrode being corresponding to the second pixel electrode for providing a second common voltage.

14. The liquid crystal display device as claimed in claim 13, wherein:
the first common electrode and the second common electrode are mutually independent; the first common electrode comprises a plurality of first common sub-electrodes and the second common electrode comprises a plurality of second common sub-electrodes; the first common sub-electrodes and the second common sub-electrodes are mutually independent; the direction along the length of each first common sub-electrode is the same as the direction of the plurality of first pixel electrodes disposed adjacently and continuously so that each first common sub-electrode is corresponding to a column or a row of the first pixel electrodes to provide the first common voltage required by the first pixel electrodes for displaying images; the direction along the length of each second common sub-electrode is the same as the direction of the plurality of second pixel electrodes disposed adjacently and continuously so that each second common sub-electrode is corresponding to a column or a row of the second pixel electrodes to provide the second common voltage required by the second pixel electrodes for displaying images.

15. The liquid crystal display device as claimed in claim 14, wherein:
all the first common sub-electrodes are electrically connected in area of the second substrate corresponding to the peripheral area of the active area of the liquid crystal display panel; and all the second common sub-electrodes are electrically connected in area of the second substrate corresponding to the peripheral area of the active area of the liquid crystal display panel.

16. The liquid crystal display device as claimed in claim 14, wherein:
the first common sub-electrodes and the second common sub-electrode have a strip shape.

17. The liquid crystal display device as claimed in claim 13, wherein:
the liquid crystal display panel comprises a first common electrode driver and a second common electrode driver; the first common electrode driver is connected to the first common electrode for inputting the first common voltage to the first common electrode; the second common electrode driver is connected to the second common electrode for inputting the second common voltage to the second common electrode.

18. The liquid crystal display device as claimed in claim 13, wherein:
the first substrate further comprises a third common electrode, and the discharging circuit comprises a first capacitor and a second capacitor; when the input terminal of the third switch is connected to either one of the first pixel electrode or the second pixel electrode, one end of the first capacitor is connected to the other pixel electrode; the other end of the first capacitor is connected to one end of the second capacitor, the other end of the second capacitor is connected to the third common electrode of the first substrate, the output terminal of the third switch is connected to between the first capacitor and the second capacitor;
wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; under the effect of the first capacitor and the second capacitor, a non-zero default voltage difference is formed between the first pixel electrode and the second pixel electrode.

19. The liquid crystal display device as claimed in claim 13, wherein:
the first substrate further comprises a third common electrode, and the discharging circuit is a discharging capacitor; the input terminal of the third switch is connected to either one of the first pixel electrode or the second pixel electrode, the output terminal of the third switch is connected to one end of the discharging capacitor, the other end of the discharging capacitor is connected to the third common electrode of the first substrate;
wherein the scan signal is inputted to the charging scan line to control the first switch and the second switch to become conductive, the data signal is inputted to the data line to drive the first pixel electrode and the second pixel electrode to display and then the inputting scan signal to the charging scan line is stopped and the scan signal is inputted to the discharging scan line to control the third switch to become conductive; controlling the capacitance of the discharging capacitor, a non-zero default voltage difference is formed between the first pixel electrode and the second pixel electrode.

20. The liquid crystal display device as claimed in claim 13, wherein:
the charging scan line, the discharging scan line, the first switch, the second switch, the third switch and the discharging circuit are all located between the first pixel electrode and the second pixel electrode.
